(19) United States
(12) Patent Application Publication
(10) Pub. No.: US 2014/0141384 A1
(43) Pub. Date: May 22, 2014

(54) Self-ligating Orthodontic Appliance with Sliding Cover

(71) Applicants: Rolf Hagelganz, Dundee, OR (US); Juergen Bathen, McMinnville, OR (US)

(72) Inventors: Rolf Hagelganz, Dundee, OR (US); Juergen Bathen, McMinnville, OR (US)

(21) Appl. No.: 13/679,019

(22) Filed: Nov. 16, 2012

(51) Int. Cl. A61C 7/28; A61C 7/30

(52) U.S. Cl. CPC A61C 7/287; A61C 7/30
USPC 433/11

(57) ABSTRACT

A self-ligating orthodontic bracket has a sliding archwire cover that has a top surface congruent with the top surface of an upper body portion having an archwire slot. The cover has a resilient locking tab that slides across the slot, bending upward as it encounters a latch and mating with the latch as it restores to secure the cover in a closed position. The cover has a modified dovetail shape with flared bottom portions that slideably engage guides for reciprocal opening and closing sliding motion.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of the Invention

This disclosure relates to improved self-locking or ligatureless orthodontic brackets.

2. Description of Related Art Including Information Disclosed Under 37 CFR 1.97 and 1.98

Several self-locking or self-ligating (ligatureless) orthodontic brackets have been designed. However, most of those have complex designs, incorporating features requiring prohibitively expensive machining operations or comprising multiple separate parts, which in turn increases the number of failure modes for such brackets. Other designs have been rejected in the marketplace due to poor quality or poor design, a lack of available features, difficulty of use, or other factors.

One such bracket is disclosed in U.S. Pat. No. 7,621,743 entitled Orthodontic Bracket. That device is a self-ligating bracket that includes a locking slide cover that entrains an archwire. However, like many sliding covers, the top surface is not smooth, which is important for patient comfort. Moreover, this device is difficult to manufacture, requiring small interlocking extensions mating in the plane of the slide and guide members on either side having sharp edges that protrude outwardly which have a tendency to irritate the mouth of the user.

Another construction is shown in published U.S. patent application 2012/0028206. In this application, a keyhole-shaped clip slides across an archwire slot and two wings on the clip engage stops to lock the clip in place. The locking clip is tiny and because it is flat, it is rather flimsy and prone to failure.

### BRIEF SUMMARY OF THE INVENTION

A self-ligating orthodontic bracket has an archwire cover that slides in a guide channel across an archwire slot. A flexible locking tab at the cover's leading edge flexes up and over a stop and a spring restoring force locks it in place.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a perspective view of a self-ligating orthodontic bracket with a sliding archwire slot cover in a closed position.

FIG. 2 is a perspective view of the orthodontic bracket of FIG. 1 with the sliding cover in the open position.

FIG. 3 is a top view of the orthodontic bracket of FIG. 1.

FIG. 4 is a sectional view taken along line 4-4 of FIG. 3.

FIG. 5 is a top view of the orthodontic bracket of FIG. 2.

FIG. 6 is a sectional view taken along line 6-6 of FIG. 5.

FIG. 7 is a sectional view taken along line 7-7 of FIG. 3.

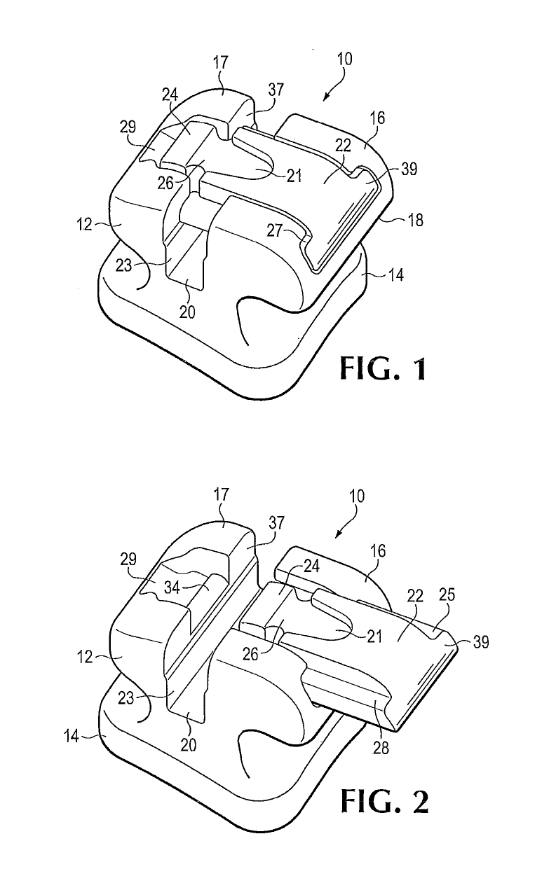

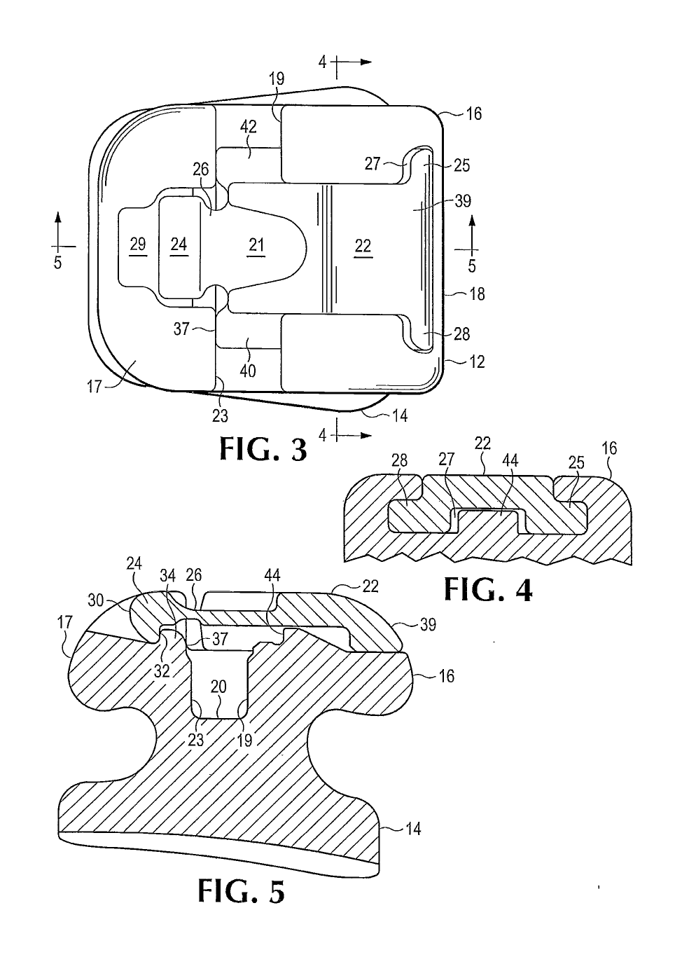

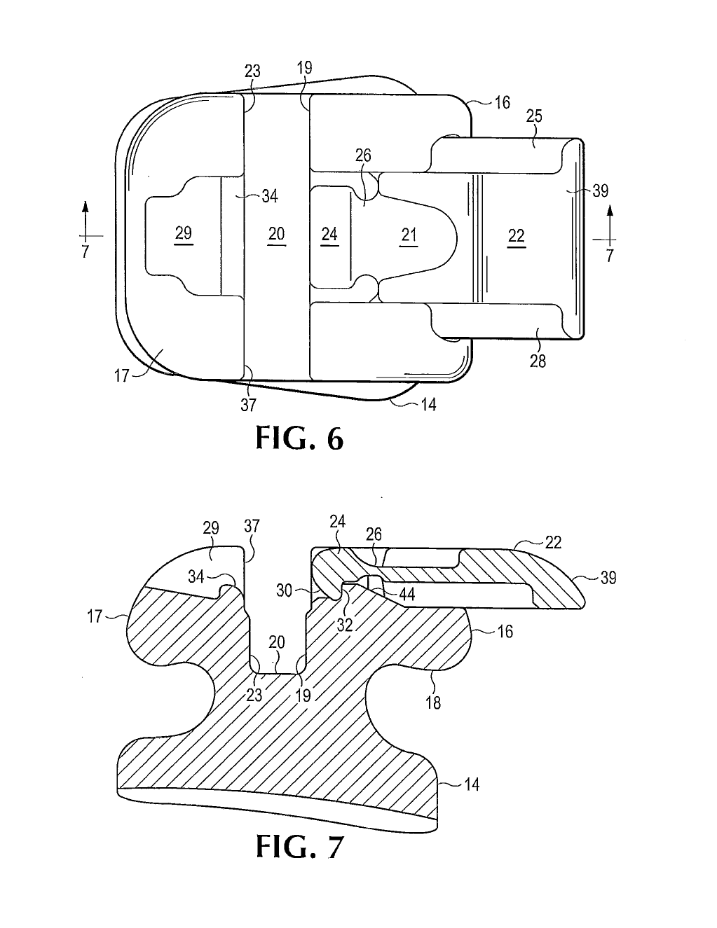

### DETAILED DESCRIPTION OF PREFERRED EMBODIMENT

Orthodontic treatment generally comprises dental work to correct irregularities of the teeth or of the relation of the teeth to surrounding anatomy. The irregularities may involve malocclusions with varying degrees of severity. Class 1 malocclusions, for example, may involve spacing irregularities such as excessive crowding or diastema (a gap between two adjacent teeth). Class 2 malocclusions may involve overbite conditions where the upper anterior teeth project labially over the lower anterior teeth. Class 3 malocclusions, in contrast, may involve underbite conditions where the upper anterior teeth close within the lingual side of the lower anterior teeth. For these and other observed irregularities, treatment typically involves installation of braces or mechanical aids for repositioning the teeth into correct orthodontic alignment.

Braces generally include orthodontic brackets configured for attachment to the labial or lingual surfaces of the teeth or for attachment to metallic bands secured around the teeth. The brackets typically include archwire slots within which a flexible yet resilient archwire may be engaged. Typically, each bracket is bonded to the tooth surface so that the bracket's archwire slot is oriented for engagement with the archwire. Various techniques are used for orienting the brackets. For example, an edgewise appliance comprises braces whereby each bracket is oriented and bonded to the tooth so that the archwire slot is perpendicular to the long axis of the root of the tooth. Alternatively, a straight-wire appliance includes braces whereby each bracket is oriented and bonded to the tooth so that the archwire slot is parallel to the occlusal plane (the biting surfaces of the teeth).

The archwire is typically a curved metallic wire having a rectangular or circular cross section that is bent or twisted prior to engagement with the brackets. The memory or restoring force exerted by the archwire upon the brackets serves to move the teeth into the desired alignment. Throughout the duration of orthodontic treatment, the orthodontist periodically adjusts the shape of the archwire (as well as the configuration of other attachments such as elastic bands and so forth) to achieve the correct orthodontic alignment.

Most brackets incurrent use incorporate tie wings or extensions that project upwardly and downwardly in a gingival-occlusal orientation and require the use of ligatures or ligating modules to hold the archwire within the archwire slots. The ligatures or ligating modules are typically donut-shaped elastomeric rings or wires that are stretched around or twisted around the tie wings.

The use of such ligatures or ligating modules presents a number of inherent disadvantages, some of which are mentioned herein. The small size of the ligatures or ligating modules requires substantial time for installation of the archwire. Because the orthodontist will typically make numerous adjustments to the archwire throughout orthodontic treatment, the orthodontist will likely remove and replace the ligatures or ligating modules numerous times. Hygiene is another problem since the use of ligatures or ligating modules increases the areas where food particles may be trapped. Further, with movement due to chewing or other activities, the ligatures or ligating modules may become detached altogether, allowing the archwire to disengage from the archwire slots.

Ligatures or ligating modules also present other limitations in terms of the forces exerted upon the brackets. For example, the labial or outward force that may be applied to a tooth having a bracket bonded to its labial surface is limited to the strength of the ligature or ligating module in the labial direction. On the same tooth, the force that may be applied in the lingual direction is not so constrained (because the force is applied against the bracket structure rather than the ligature or ligation module). Similarly, the longitudinal (or mesial-distal) forces, which may be applied along the direction of the archwire, may be limited or defined by the friction between the ligature or ligation module and the archwire. By contrast, a means for locking the archwire within the archwire slot would enhance the forces that may be exerted along the direction of the archwire. Likewise, a means for slideably retaining the archwire within the archwire slot would allow greater flexibility than available from brackets requiring the use of ligatures or ligation modules.

A self-ligating orthodontic bracket 10 includes two separate parts, which together comprise a bracket assembly. A main body 12 includes a base portion 14 that is secured to a patient's tooth (not shown) with an adhesive or the like. The base portion 14 supports an upper tie wing portion 16 that includes a pair of tie wings 17, 18, one extending in the gingival direction and the other oriented in the occlusal direction. The upper tie wing portion 16 has an archwire slot 20 that extends in a mesial-distal direction when the bracket 10 is installed on a patient's tooth. The second part is a sliding cover 22 that engages the upper tie wing portion 16 and is selectively opened and closed over the archwire slot so as to retain the archwire (not shown) or to provide access to the archwire for installation, removal and/or adjustment.

The sliding cover 22 is a single piece construction that, when locked over the archwire slot 20, provides a smooth and continuous upper surface to the bracket assembly 10. The cover 22 is dimensioned so that it has an upper surface that is at the same height and shape as the tie wing portion 16, and is congruent with the upper surface of the tie wing portion 16 when the slide 22 is in a locked position. Thus, the overall upper surface is smooth and there are no protruding parts to irritate the patient's mouth.

The sliding cover 22 has a lower portion 24 that resembles a semi-dovetail shape. Rounded lower side portions 26, 28 flare outwardly beyond the width of the top surface portion. These side portions engage a guide channel 27 in the upper tie wing portion 16 of the bracket 20. The guide channel 27 overlaps the side portions of the cover 26, 28 and retains the cover 22 as it slides forward. A depression 21 in the top surface of the cover permits an orthodontist to use a tool to manipulate the sliding cover from a locked to an unlocked position. On the opposite side of the archwire slot is a receiving aperture 29 into which a locking tab nests when the slide cover is in a fully closed position.

The sliding cover 22 has a locking tab 24 on its forward end. The locking tab is joined to the main body of the sliding cover by a narrow neck 26 of reduced height and width. The neck 26 provides elasticity so that the locking tab 24 can flex in an upward direction relative to the base 14 and spring back into a locked position under the restoring force of the flexible neck 26. No particular shape is necessary for providing enough flex for the locking tab 24, and other shapes such as a relief channel or merely making the tab out of a material that permits it to act like a leaf spring are also contemplated. The locking tab 24 has a rounded leading edge 30 in front and a straight undercut 32 behind the leading edge so that the front part of the locking tab 24 forms a hook.

The leading edge of the tab 24 slides across a stop 34 as the cover 22 is urged across the archwire slot 20. The stop 34 is curved or angled so that the rounded leading edge 30 easily slides up and over it. This forces the tab 24 to flex upwardly. Once the leading edge 30 clears the stop 34, it snaps back onto the stop effectively latching the cover 22 in a closed position. The sliding cover 22 has a length dimension such that when the cover is closed, the forward ends 40, 42 of the flared side portions 26, 28 abut a wall 37 of the archwire slot 20, and the back end 39 of the sliding cover 22 is flush with the upper tie wing portion 16 forming essentially a smooth and continuous surface.

To open the archwire slot 20, a tool (not shown) is inserted into the depression 21 in the top of the cover 22 and the cover is pulled back. The locking tab 24 flexes upward as the cover 22 retracts, clearing the stop 34. The neck 26 is formed so that the spring action of the tab is not too stiff to resist the ramping action of the tab 24 over the stop 34 as the cover is retracted.

In its retracted position the locking tab 24 rests against a second stop 44 on the opposite side of the archwire slot. This prevents the sliding cover from becoming separated from the body of the bracket. It also defines the amount of travel of the sliding cover from open position to closed position.

The terms and expressions that have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1-10. (canceled)

11. A self ligating orthodontic bracket, comprising a base and an upper tie wing body, the upper tie wing body having an archwire slot for receiving an archwire and a sliding cover for retaining said archwire in said slot, said sliding cover having a forward end comprising a resilient locking tab, wherein the resilient locking tab is adapted to flex in an upward direction relative to said base, said upper tie wing body having a latch on a first side of said archwire slot for retaining said resilient locking tab when said sliding cover is urged forward from a second side of said archwire slot towards said first side of said archwire slot causing said resilient locking tab to flex upwardly as it travels across said latch then restore so as to engage said latch and lock said sliding cover in a closed position.

12. The self-ligating orthodontic bracket of claim 11, wherein said sliding cover has a narrow neck adjacent said resilient locking tab for allowing said resilient locking tab to flex as said resilient locking tab slides across said latch.

13. The self-ligating orthodontic bracket of claim 12, wherein said latch has a curved or angled side adjacent said archwire slot and wherein said resilient locking tab has a leading edge angled or curved to facilitate a sliding motion across said curved or angled side of said latch.

14. The self-ligating orthodontic bracket of claim 13, wherein said resilient locking tab includes a substantially straight back surface.

15. The self-ligating orthodontic bracket of claim 13, wherein said upper tie wing body includes a stop on said first side of said archwire slot for engaging said resilient

16. The self-ligating orthodontic bracket of claim 11, wherein a first tie wing portion of said upper body includes a guide channel and said sliding cover includes side flange portions adapted to slidingly engage said guide channel.

17. The self-ligating orthodontic bracket of claim 16 wherein said upper tie wing body has a top surface and said sliding cover has a top surface level with the top surface of said upper tie wing body.

18. The self-ligating orthodontic bracket of claim 6 wherein a second portion of said upper tie wing body includes an aperture configured to fit said resilient locking tab thereby forming a congruent top surface.

19. A self-ligating orthodontic bracket comprising a first part adapted to be secured to a patient's tooth, said first part having an upper body including first and second tie wing portions separated by an archwire slot, a first tie wing portion having a guide channel for supporting and guiding a sliding cover as said cover moves from an open position to a closed position, and a second tie wing portion having a latch adjacent said archwire slot, said sliding cover having a top surface at a height level with a top surface of said first tie wing portion, and outwardly flared lower surfaces engageable by said guide channel, and a vertically flexible locking tab adapted to flex vertically when engaging said latch and then restore thereby locking said sliding cover in place.

20. The self-ligating orthodontic bracket of claim 9 wherein said vertically flexible locking tab includes a rounded or curved leading portion for sliding over said latch and a straight undercut portion for engaging said latch.

21. A self ligating orthodontic appliance comprising an upper body having first and second tie wing portions, an archwire slot extending in a mesial-distal direction situated between said first and second tie wing portions, said first tie wing portion including a guide channel and said second tie wing portion including a receiving aperture and a latch, a sliding cover adapted to slide within said guide channel from an open position wherein said archwire slot is uncovered to a closed position wherein said archwire slot is covered, said sliding cover having lower side portions fitting within said guide channel and a forward end comprising a flexible locking tab adapted to flex upwardly when engaging said latch and to lock said sliding cover in a closed position when said sliding cover is urged across said archwire slot.

22. The self-ligating orthodontic appliance of claim 21 wherein said sliding cover has a narrow neck of reduced dimension adjacent said forward end to thereby permit said locking tab to flex upwardly over said latch.

23. The self-ligating orthodontic appliance of claim 22 further including a stop on said first tie wing portion for retaining said sliding cover in said guide channel when said sliding cover is in an open position.

24. The self-ligating orthodontic appliance of claim 21 wherein said lower side portions of said sliding cover have a substantially dovetail shape.

25. The self-ligating orthodontic appliance of claim 21 wherein said sliding cover includes lower side portions on either side of said locking tab, said lower side portions having forward ends extending across said archwire slot in a closed position, and wherein said receiving aperture receives said locking tab in said closed position.

26. The self-ligating orthodontic appliance of claim 25 wherein said locking tab includes a rounded leading edge and a straight undercut behind said edge to thereby form a hook for engaging said latch.
